(19) United States
(12) Patent Application Publication
(10) Pub. No.: US 2025/0190102 A1
(43) Pub. Date: Jun. 12, 2025

(54) OFF-PLOT GATE INDICATORS AND NAVIGATION TOOLS FOR CELL DATA ANALYSIS

(71) Applicant: Life Technologies Corporation, Carlsbad, CA (US)

(72) Inventors: Bethan Jones, Carlsbad, CA (US); Matthew Shallice, Carlsbad, CA (US); Laurel Stone, Carlsbad, CA (US)

(21) Appl. No.: 18/974,353

(22) Filed: Dec. 9, 2024

Related U.S. Application Data
(60) Provisional application No. 63/607,948, filed on Dec. 8, 2023.

(51) Int. Cl. G06F 3/04847; G06F 3/04842

(52) U.S. Cl. CPC G06F 3/04847; G06F 3/04842

(57) ABSTRACT

Methods, systems, and apparatuses for navigating data visualizations within a user interface. One method includes providing particle data, which may be captured by an imagin device, to the user interface and receiving, from the user interface, a plurality of coordinates for a gate related to the particle data. The method also includes receiving, from the user interface, a configuration for a current view of the particle data, and, in response to determining the gate is off-plot for the current view based on the plurality of coordinates for the gate and the configuration for the current view, adding a selectable indicator to the current view of the particle data representing the gate. The method further includes, in response to receiving a selection of the indicator, modifying the current view of the particle data to display the gate.

### RELATED APPLICATIONS

This application claims priority to U.S. Provisional Application No. 63/607,948, filed Dec. 8, 2023, the entire content of which is incorporated by reference herein.

### FIELD

This disclosure generally relates to data processing in analyzing particle data. More specifically, the present disclosure relates to analyzing flow cytometry (FC) data and creating visualizations and associated user interfaces.

### BACKGROUND

Flow cytometry is a technique used to detect and measure physical and chemical characteristics of a population of cells or particles. Flow cytometry (FC) combines the high-event-rate nature of flow cytometry with the advantages of single-cell image acquisition associated with microscopy.

### BRIEF DESCRIPTION OF THE DRAWINGS

Features and advantages of the present technology will become more apparent from the following detailed description of example embodiments thereof taken in conjunction with the accompanying drawings in which:

FIG. 1 is a block diagram of an analyzer system configured to perform one or more of the methods disclosed herein, in accordance with one or more embodiments of the present disclosure.

FIGS. 2A-2D are charts showing an example biplot, in accordance with one or more embodiments of the present disclosure.

FIG. 3A and 3B are charts showing an example histogram, in accordance with one or more embodiments of the present disclosure.

FIGS. 4A and 4B are example histogram plots that include an off-plot gate indicator, in accordance with one or more embodiments of the present disclosure.

FIG. 5 is an example chart 500 that includes an off-plot gate indicator boxes in each direction, in accordance with one or more embodiments of the present disclosure.

FIG. 6 is an example mockup chart showing a cross-shaped off-plot indicator box, in accordance with one or more embodiments of the present disclosure.

FIG. 7 is an example mockup chart 700 showing quadrant plots, in accordance with one or more embodiments of the present disclosure.

FIGS. 8A and 8B are example charts that include a context menu, in accordance with one or more embodiments of the present disclosure.

FIG. 9 is an example user interface for exporting a plot including an off-plot gate indicator, in accordance with one or more embodiments of the present disclosure.

FIG. 10 is an example user interfaces for customizing functionality associated with off-plot gate indicators within a user interface, in accordance with one or more embodiments of the present disclosure.

FIG. 11 is a flowchart illustrating an example method of navigation data visualizations, in accordance with one or more embodiments of the present disclosure.

While the present technology is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

Unless otherwise defined, all technical and scientific terms used herein have the same meaning as commonly understood by one of ordinary skill in the art. In case of conflict, the present document, including definitions, will control. Example methods and systems are described below, although methods and systems similar or equivalent to those described herein can be used in practice or testing of the present disclosure. All publications, patent applications, patents and other references mentioned herein are incorporated by reference in their entirety. The systems, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

In addition, unless otherwise indicated, numbers expressing quantities, constituents, distances, or other measurements used in the specification and claims are to be understood as being modified by the term “about.” The terms “about,” “approximately,” “substantially,” or their equivalents, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

The present disclosure is described with reference to the drawings, where like reference numerals are used to refer to like elements throughout. In the following description, for purposes of explanation, numbers of specific details are set forth in order to provide an improved understanding of the present disclosure. It may be evident, however, that the systems and methods of the present disclosure may be practiced without one or more of these specific details. In other instances, well-known structures and devices are shown in block diagram form to facilitate describing the systems and methods of the present disclosure. There is no specific requirement that a system, method, or technique relating to analyzing an image include all of the details characterized herein to obtain some benefit according to the present disclosure. Thus, the specific examples characterized herein are meant to be example applications of the techniques described and alternatives are possible.

During flow cytometry data analysis, users may create plots to visualize data and generate gates on these plots to bin subsets of data for further analysis. For example, a user can draw or add a gate (e.g., with a predetermined or adjustable size and/or shape) to a displayed visualization using various user interface tools. However, if a user changes a configuration of the plot (e.g., by changing a scale range, changing plot parameters, or the like), a gate can go off-plot. As used herein, an “off-plot gate” is a gate whose coordinates do not exist within a set scale type or range for a current view (e.g., plot) of flow cytometry data. For example, scales for data points using some parameters (e.g., morphometric and processing-based parameters) may not fall within the same scale range as other parameters, such as, for example, traditional fluorescent and scatter parameters (e.g., particle count with a scale range, such as, for example, 0-<10\hat{ }6, or a logic based parameter with data points of either a 0 or a 1 (e.g., indicating whether a complete cell is not in an image)). Additionally, as users navigate through diverse scale ranges during data discovery, gates may become off-plot.

To address these and other technical issues with existing data visualization and navigation technology, embodiments described herein provide off-plot gate indicators and associated navigation tools for flow cytometry plots that enable a user to more efficiently and effectively visualize and navigate to gates that are not on scale. For example, the indicators and navigation tools described herein allow users to navigate to these gates during data analysis for, for example, strategy modification and gate removal assisting with the overall processing capabilities.

For example, off-plot gate indicators and navigation tools as described herein enable users to quickly navigate around a data space (also referred to herein as a workspace) and interact with gates, where axis scales can vary from (e.g., 0-4 to 0-10\hat{ }6) depending on the selected parameters. For example, in some embodiments, the allowable minimum for log scaling is the minimum logarithmic value to 2\hat{ }31-2 and the allowable maximum for log scaling is the minimum logarithmic value +1 to 2\hat{ }31-1. Similarly, for linear and HyperLog scaling (i.e., a log-like transform function that admits negative, zero, and positive values on the scale), the allowable minimum is −2\hat{ }31 to +2\hat{ }31-2 and the allowable maximum is −2\hat{ }31+1 to +2\hat{ }31-1.

The described systems and methods provide navigation tools for seamlessly interacting with data binning strategies and making adjustments when changing scale. The systems and methods provide also user interfaces and tools for interacting with and deleting redundant gates, thus removing such gates from hierarchical statistical outputs.

Generally, when a gate(s) is off-plot, the systems and methods described herein add an icon within (i.e., generally associated with) the plot space, wherein the icon is selectable by a user to extend or rescale the axis to the minimum and maximum values of a) the x-axis when the plot (current view) is a histogram plot or b) both axes when the plot (current view) is a biplot, as determined by gate/parameter range (PnR) bounds. On-plot indicators on both histogram and bi-plots are provided to indicate whether off-plot gates exist. In some cases, these icons (also referred to herein as indicators) show a direction in data space (e.g., a directional indicator such as an arrow or pointer (chevron)) where gates are off-plot. Also, when one or more gates are off-plot, a provided indicator allows a user to expand or otherwise modify a current view (plot) to the furthest boundary of all gates present (e.g., for a certain axis). Furthermore, the indicators described herein are selectable to navigate to the boundary of a single gate of interest by, for example, expanding an axis to the extent of the gate bounds. The ability to export on-plot indicators can also be provided during plot export. In some implementations, one or more of the indicator features and associated functionality described herein can be customized (e.g., toggled on and off) for particular needs and preferences and further optimize the speed and accuracy at using and navigating provided user interfaces.

### Example Analyzer System

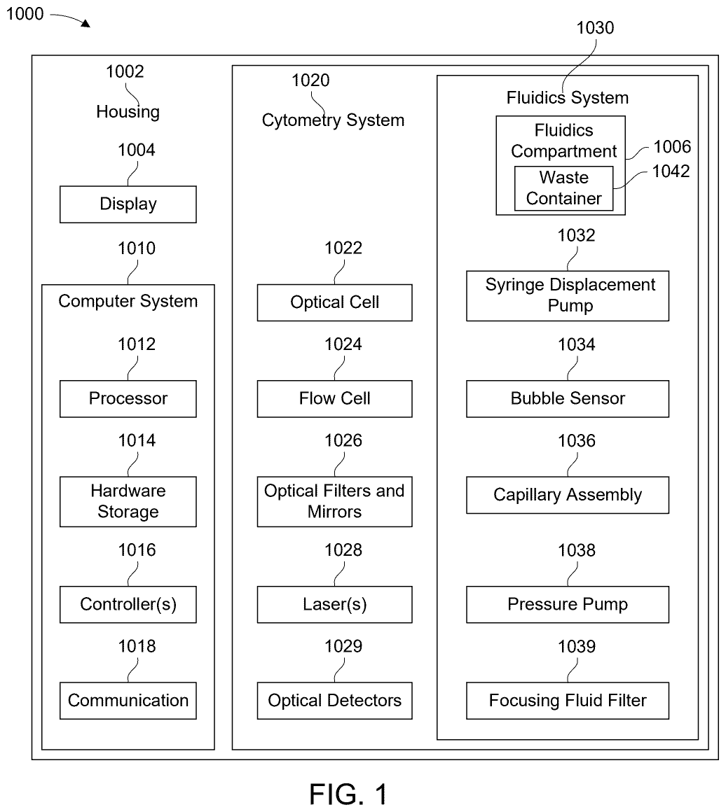

FIG. 1 schematically illustrates an analyzer system 1000 in accordance with one or more embodiments of the present disclosure. The analyzer system 1000 is configurable to perform one or more of the methods disclosed herein. The analyzer system 1000 illustrated in FIG. 1 includes a housing 1002 that encloses and protects the optics and computing systems used for imaging flow cytometry (IFC) and related data analysis. However, it should be understood that the methods described herein are not limited to use with imaging flow cytometers but may be used with other types of instruments, including, for example, non-imaging flow cytometers. For example, in some embodiments, the methods described herein may be performed using an Attune™ CytPix™ Flow Cytometer, which uses imaging, or an Attune™ NxT Flow Cytometer, which does not use imaging. In particular, embodiments described herein are not specific to the images but to data displayed (e.g., in graphical form) that can be derived from image analysis or standard fluorometric flow cytometry.

As illustrated in FIG. 1, the analyzer system 1000 includes a computer system 1010 and a cytometry system 1020 included therewith. FIG. 1 conceptually represents the computer system 1010 and the cytometry system 1020 as disposed within the housing 1002 of the analyzer system 1000. However, one will appreciate, in view of the present disclosure, that any portion of the computer system 1010 or the cytometry system 1020 may be disposed at least partially outside of the housing 1002 within the scope of the disclosed embodiments. However, in other embodiments, the functionality described herein as being performed via the computer system 1010 may be performed locally by the cytometry system 1020.

The computer system 1010 of the analyzer system 1000 may comprise various components, such as electronic processing device(s) 1012 (also “central processing unit” (CPU), “processor,” and “computer processor” herein), hardware storage device(s) 1014, controller(s) 1016, and communications module(s) 1018.

The electronic processing device(s) 1012 may comprise one or more sets of electronic circuitry that include any number of logic units, registers, and/or control units to facilitate the execution of computer-readable instructions (e.g., instructions that form a computer program). Such computer-readable instructions may be stored within non-transitory computer readable storage medium, such as the hardware storage device(s) 1014, which may comprise physical system memory and which may be volatile, non-volatile, or some combination thereof. Computer readable instructions (forming a computer program) for performing the functionality described herein may be implemented as program modules, such as functions, objects, application programming interface (API), data structures, and the like. The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

The controller(s) 1016 may comprise any suitable software components (e.g., set of computer-executable instructions) and/or hardware components (e.g., an application-specific integrated circuit, or other special-purpose hardware component(s)) operable to control one or more physical apparatuses of the analyzer system 1000, such as portions of the cytometry system 1020.

It should be understood that the functionality described herein may be implemented via the computer system 1010 and may be implemented in a single processor environment or in a distributed processor environment and the functionality described herein may be distributed across multiple computers or systems or may be co-located in a single processor or system. Also, although the computer system 1010 is illustrated in FIG. 1 as being local to the cytometry system 1020 (i.e., contained within a common housing), in some embodiments, functionality described herein may be performed via a computer system remote to the cytometry system 1020 and such a remote computer system may include similar components as the computer system 1010 described herein. In such a remote configuration, the remote computer system may obtain flow cytometry data from the cytometry system 1020, other data sources, various intermediary devices (e.g., data storage devices), or the like and the data may be received over a wired connection, a wireless connection, or a combination thereof.

Returning to FIG. 1, the communication module(s) 1018 may comprise any combination of software or hardware components that are operable to facilitate communication between on-system components/devices and/or with off-system components/devices. For example, the communications module(s) 1018 may comprise ports, buses, or other physical connection apparatuses for communicating with other devices (e.g., universal serial bus (USB) port, Secure Digital (SD) card reader, and/or other apparatus). Additionally, or alternatively, the communications module(s) 1018 may comprise systems operable to communicate wirelessly with external systems and/or devices through any suitable communication channel(s), such as, by way of non-limiting example, Bluetooth®, ultra-wideband, wireless local area network (WLAN), infrared communication, and/or others.

As shown in FIG. 1, the analyzer system 1000 includes a cytometry system 1020 having an optical cell 1022, a flow cell 1024, optical filters and mirrors 1026, multiple lasers 1028, optical detectors 1029, and a fluidics system 1030. The fluidics system 1030 includes a syringe displacement pump 1032, a bubble sensor 1034, a capillary assembly 1036, a pressure pump 1038, and a focusing fluid filter 1039.

The cytometry system 1020 may use acoustic pressure to confine injected particles to a tight central line as a sample passes through the optical cell 1022 for interrogation. Acoustic focusing places the interrogated particles within a narrow depth-of-field, which allows the production of in-focus images at standard flow cytometry rates. System and methods for acoustic focusing have been described in U.S. Pat. No. 8,714,014, filed on Sep. 11, 2008; U.S. Pat. No. 8,309,408, filed on Sep. 26, 2008; U.S. Pat. No. 8,134,705, filed on Sep. 26, 2008; and U.S. Pat. No. 8,873,051, filed on Mar. 22, 2013, all of which are incorporated by reference in their entirety.

In some embodiments, a sample is loaded into the cytometry system 1020 via the sample injection port. The sample is delivered to the flow cell 1024 after a user defines collection criteria. The sample is pushed through the capillary assembly 1036 and wrapped in a sheath of focusing fluid before it is intercepted by the laser beam for interrogation. In some embodiments, the capillary assembly 1036 is an acoustic resonant device that focuses cells or particles into a single, tight line using a capillary coupled to a piezoelectric transducer.

As the sample traverses an interrogation point, the cytometry system 1020 uses the lasers 1028 to illuminate the particles or cells in the sample, which scatter the laser light and emit fluorescent light from fluorescent dyes attached to them. The optical filters and mirrors 1026 route specified wavelengths of the resulting light scatter and fluorescence signals to the designated optical detectors 1029 (e.g., PMT detectors and a diode detector (FSC)).

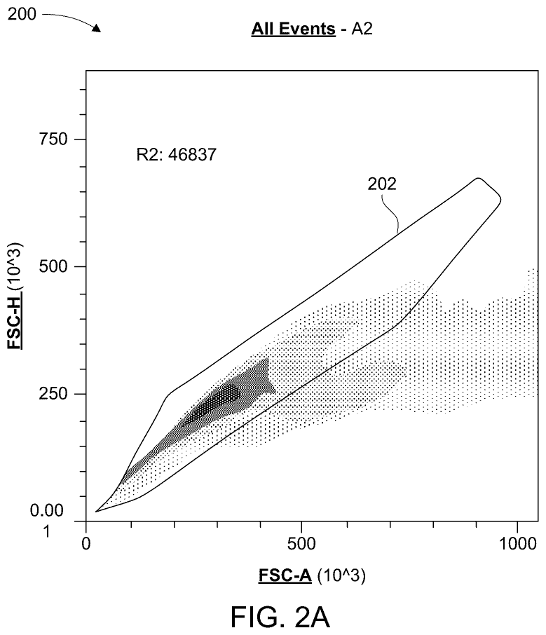

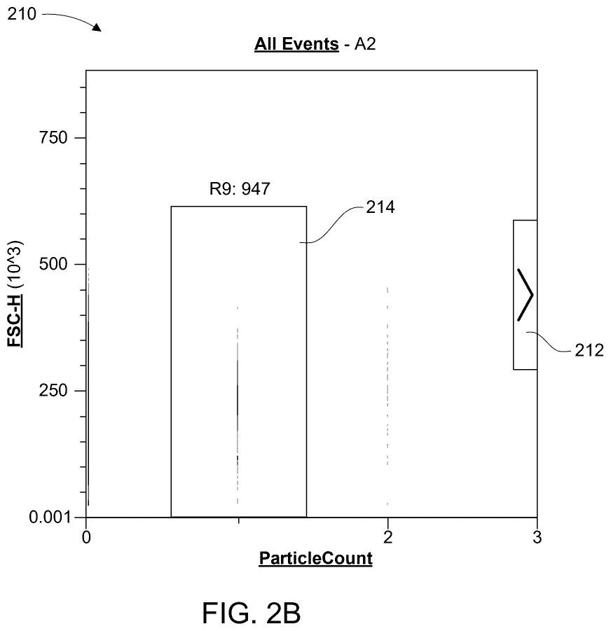

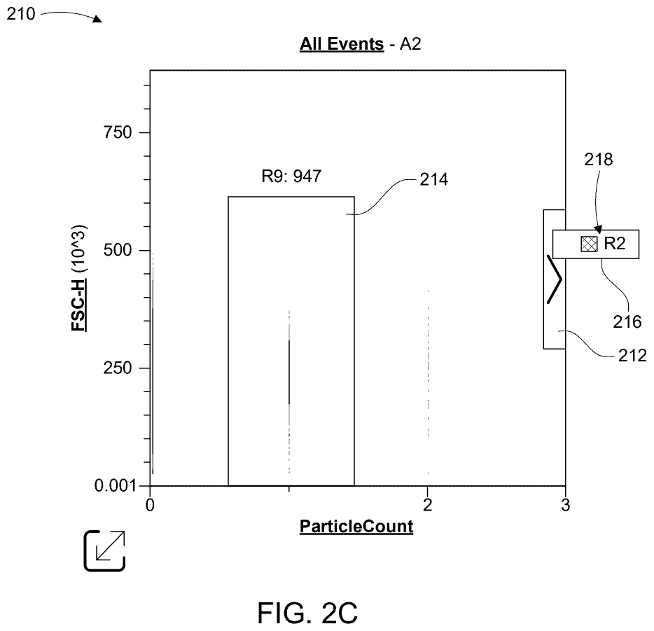

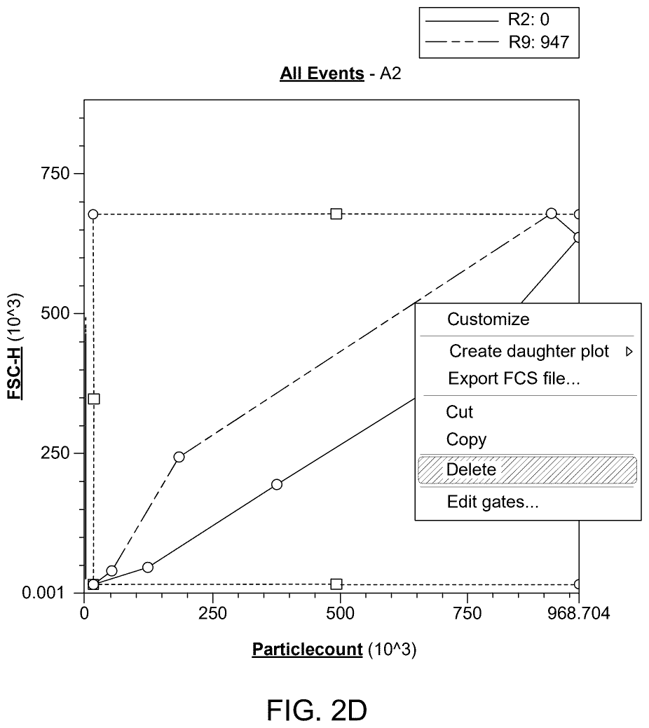

The optical detectors 1029 convert the fluorescence signals and collected light scatter into electrical signals (i.e., voltage pulses), which are proportional to the intensity of the light received by the detectors. The electrical signals are provided to the computer system 1010 for further processing. For example, the computer system 1010 may generate biplots (e.g., FIGS. 2A-2D) using the received electrical signals.

The fluidics system 1030 handles the flow of fluids including the fluid functions during data collection. In some cases, the sample to be analyzed is driven by the syringe displacement pump 1032 and passes through the bubble sensor 1034 along the path of the sample loop before arriving at the capillary assembly 1036. The continuous flow pressure pump 1038 controls the focusing fluid through the focusing fluid filter 1039 and combines it with the sample fluid to allow for particle hydrodynamic focusing.

In some embodiments, the capillary assembly 1036 is an acoustic resonant device that focuses cells or particles in the sample fluid into a single tight line (i.e., the sample core) using a capillary coupled to a single piezoelectric transducer. The capillary carries the sample core upward through the center of the optical cell, where the particles to be analyzed are intercepted by a tightly-focused laser beam for interrogation. After passing through the optical cell, the stream arrives at a waste container 1042 (included in the fluidics compartment 1006).

FIG. 1 furthermore illustrates that, in some instances, the analyzer system 1000 includes a display 1004. The display 1004 may be in communication, whether directly or indirectly, with various other components of the analyzer system 1000, such as the computer system 1010 or the cytometry system 1020 thereof. For example, the analyzer system 1000 may capture images using components of the cytometry system 1020, and captured images may be processed and/or stored using components of the computer system 1010 (e.g., electronic processing device(s) 1012, hardware storage device(s) 1014, etc.), and the processed and/or stored images may be displayed on the display 1004 for observation by one or more users.

One will appreciate, in view of the present disclosure, that an analyzer system may comprise additional or alternative components relative to those shown and described with reference to FIG. 1, and that such components may be organized and/or distributed in various manners.

### Example Charts, Dataspaces, and User Interfaces

As described above, flow cytometry data may be presented (visualized) within a user interface in various manner. FIG. 2A is a density dot plot (dataspace) 200 of an example biplot. The density dot plot 200 includes a forward scatter area (FSC-A) on the x-axis and forward scatter height (FSC-H) on the y-axis that includes on-plot indicators and navigation tools. The example biplot may be used by a user of a flow cytometry system, such as the analyzer system 1000, to analyze data from an experiment. The example density dot plot 200 includes a gate 202 (e.g., added to the dot plot 200 by a user) that is labeled R2 and can be used to define particular particles.

FIG. 2B is a chart 210 of the example biplot where the x-axis is changed to the AI-derived parameter “ParticleCount” and the scale changes from 0-3. An off-plot gate indicator 212 is provided indicating R2 is to the “right” of the data in data space. The chart 210 may be employed when, for example, the biplot data is processed using AI to see how many single particles the algorithms have analyzed in the samples to understand more about the dataset.

As illustrated in FIG. 2B, in the chart 210, a new gate 214 is added (R9). For example, a user may decide that the gate 202 (labeled R2, see FIG. 2A) was not accurate and gates data in the new gate 214 (R9). To allow for quick navigation to the old gate 202 (R2) and delete the gate 202, the off-plot gate indicator 212 is selectable by a user (e.g., by clicking on the indicator 212 with a cursor control device or through a touchscreen) and, in some embodiments, in response to receiving a selection of the indicator 212 (e.g., a right click as described in more detail below), the user interface including the chart 210 is updated to provide a list 216 of one or more off-plot gates represented by the off-plot gate indicator 212. For example, as illustrated in FIG. 2C, the off-plot gate indicator 212 represents one gate (i.e., the gate 202) and, thus, the list 216 includes a selectable icon 218 for the gate 202. In response to receiving a selection of the icon 218, the chart 210 is reconfigured to display the selected gate 202 (e.g., the scale is changed and set such that the selected gate 202 is fully displayed within the chart 210), such as, for example, by displaying the dataspace 200 as illustrated in FIG. 2A. As illustrated in FIG. 2D, when a plot includes a gate, the gate (as represented visually) may be selectable such that, in response to receiving a selection of a gate, a menu of functions is provided, which may include selectable options for editing the gate, copying the gate, deleting the gate, or the like.

It should be understood that when an off-plot gate indicator represents multiple off-plot gates, selecting the off-plot gate indicator (e.g., with a right click, a mouse over, etc.) may display a list including a selectable icon for each represented gate. The icons may be color-coded, such as, for example, to match different colors used in the charts to distinguish different gates.

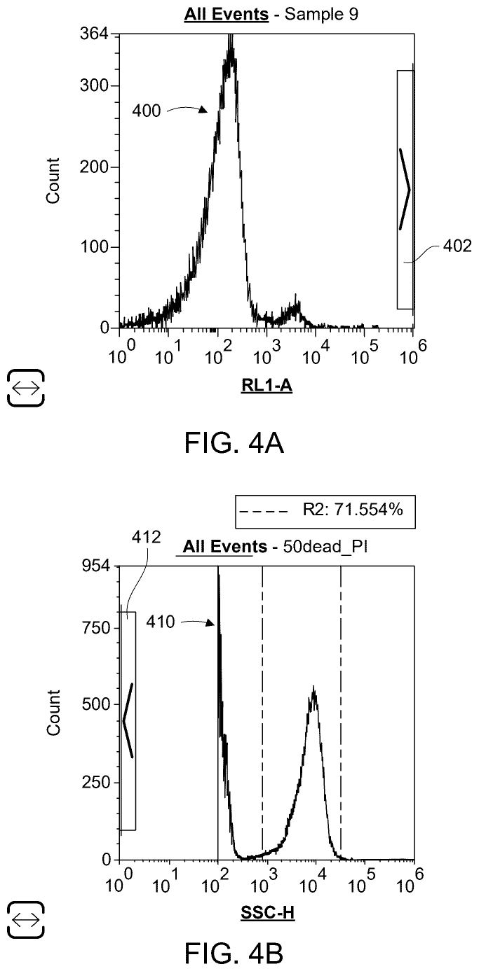

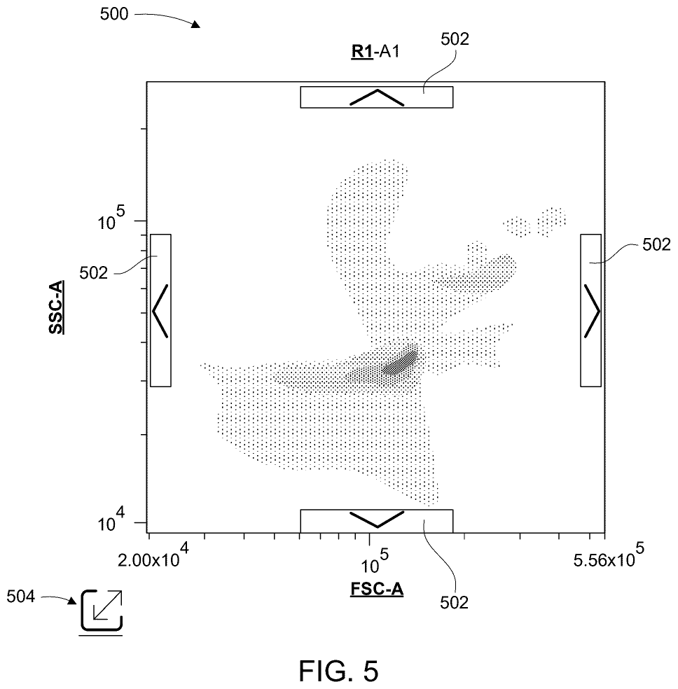

It should be understood that the off-plot gate indicator 212 may be positioned within the chart (plot) to indicate a direction on the displayed scale where the off-plot gates arc positioned. For example, the off-plot gate indicator 212 is displayed on the right edge of the chart 210 to represent that the gate 202 is positioned to the right of the x-axis scale (e.g., beyond 3 on the x-axis scale). For example, FIGS. 4A and 4B are example histogram plots 400 and 410, wherein each plot includes an off-plot gate indicator 402 and 412, respectively. As illustrated in FIGS. 4A and 4B, when one or more histogram gates are completely off-plot, a rectangular off-plot gate indicator box is displayed (e.g., 1/22 of plot width and 0.7 of plot height) to either the left and/or right of the extent of the x-axis (dependent on off-plot position of gate). In some embodiments, the off-plot gate indicator is displayed flush with the vertical edge of the plot adjacent to location of the off-plot gate(s). As illustrated in FIG. 5, a chart 500 may include one or more indicators 502 as applicable for the current gate and may include an indicator 502 in each direction if applicable.

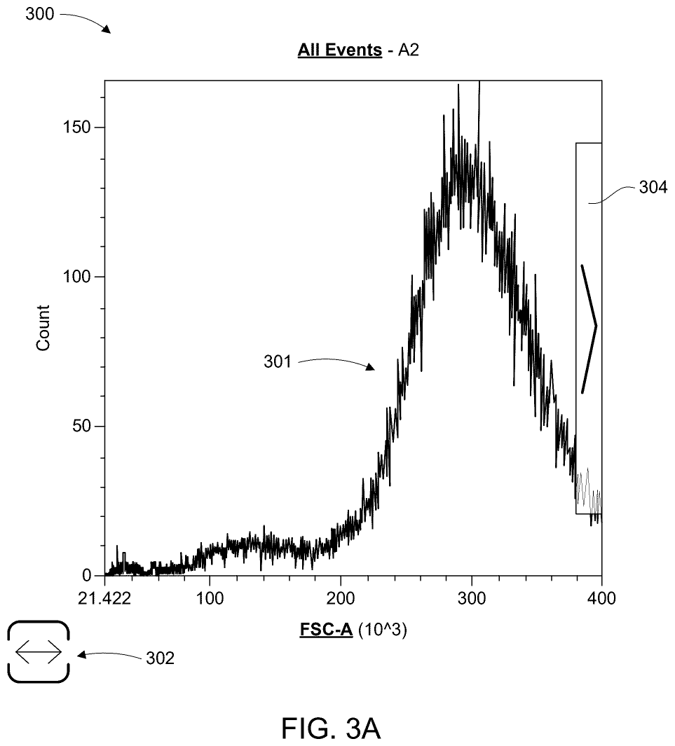

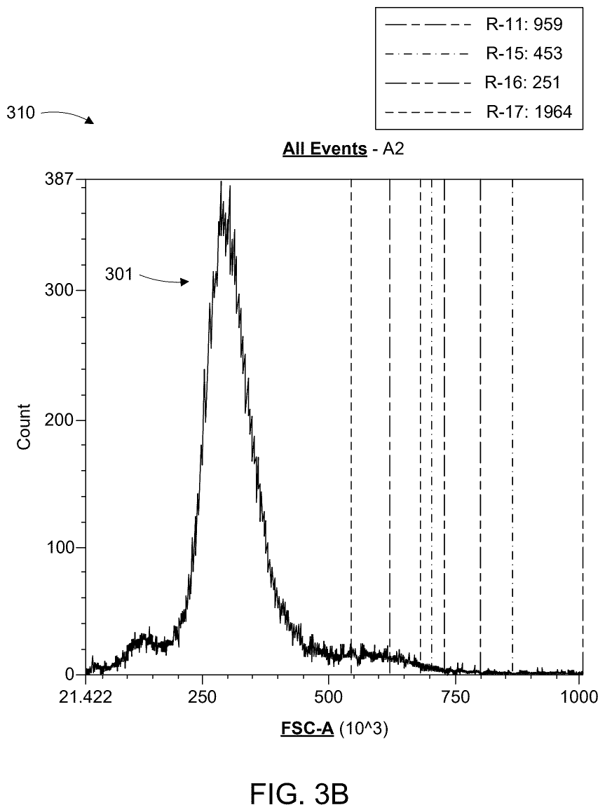

FIG. 3A is chart 300 showing an example histogram 301, an icon 302, and an off-plot gate indicator 304. FIG. 3B is a chart 310 showing the example histogram 301 expanded to the extent of the boundaries of gate(s) represented by the off-plot gate indicator 304. The off-plot gate indicator 304 represents multiple gates (labeled R11, R15, R16, and R17 in FIG. 3B). The expanded chart 310 includes the gates assigned to the histogram allowing the user to interact with these gates. In some cases, the chart 310 is expanded from the chart 300 in response to selection of the icon 302. As described above, in response to receiving a selection of the off-plot gate indicator 304, a list of gates represented by the indicator 304 is provided. In some embodiments, multiple icons within such a list can be selectable to select one or a subset of gates to display within the chart 310. To expand the chart 310 when multiple gates are selected (e.g., through a list associated with the off-plot gate indicator 304 or the icon 302), the scale mode may be set to manual with the minimum and maximum values determined by the gate/parameter range (PnR) bounds, which may include a negative space for HyperLog and linear scales.

The icon 302 may be referred to as an axis expansion indicator or button that may be positioned, for example, at the bottom left of a histogram or dual-parameter plot outside plot space when one or more gates are completely off-plot. The icon 302 may be used as a selectable axis expansion indicator or button for expanding plot axes when the plot is implemented as a histogram. A different icon may be with the plot is implemented as a dual parameter. For example, FIG. 5 illustrates an icon 504 that may be used as an axis expansion indicator or button for expanding plot axes for a dual-parameter plot implementation. Accordingly, different icons may be used for the axis expansion indicator depending on the plot type or implementation. It should be understood that various positions and icons may be used for the axis expansion indicators.

In some embodiments, in response to selection of an axis expansion indicator and the resulting chart expansion, the axis expansion indicator may be removed from the user interface (e.g., since no further expansion is available). However, when any axis is manually adjusted after expansion of a chart via an axis expansion indicator, the axis expansion button may reappear when one or more gates exhibit off-plot behavior following the manual adjustment. Also, in some embodiments, the axis expansion indicator (icon) may not change size or become distorted or mis-rendered when axes are changed (e.g., to log scale) or when plot zoom in/out is utilized.

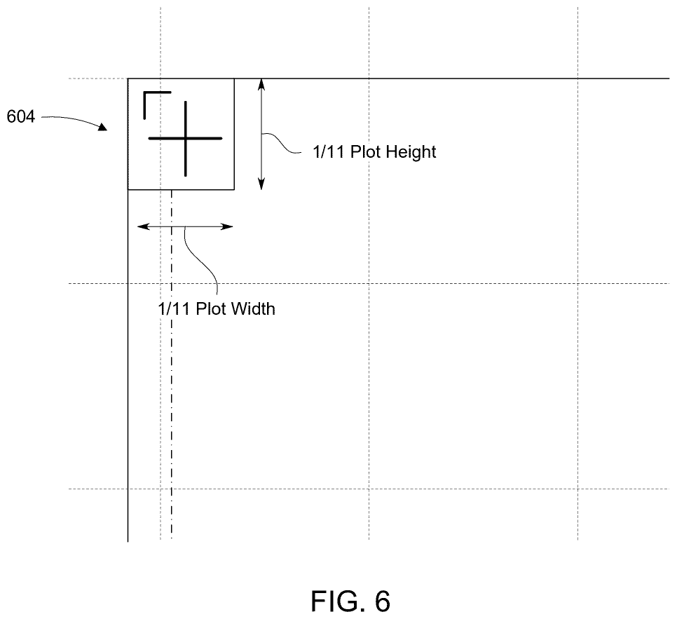

As illustrated in FIGS. 2B, 2C, 3A, 4A, 4B, and 5, an off-plot gate indicator may include an icon (e.g., a chevron, such as, for example, indicators 212, 304, 402, 412, and 520) that directs a user where the off-plot gates are located. In some implementations, such a chevron icon may be used as an off-plot indicator for a histogram and biplots. In some implementations, when the center point of a quadrant gate is off-plot, a cross-shaped icon (see, e.g., indicator 604 in FIG. 6) may be added to an off-plot gate indicator box with, for example, dimensions as shown in FIG. 6.

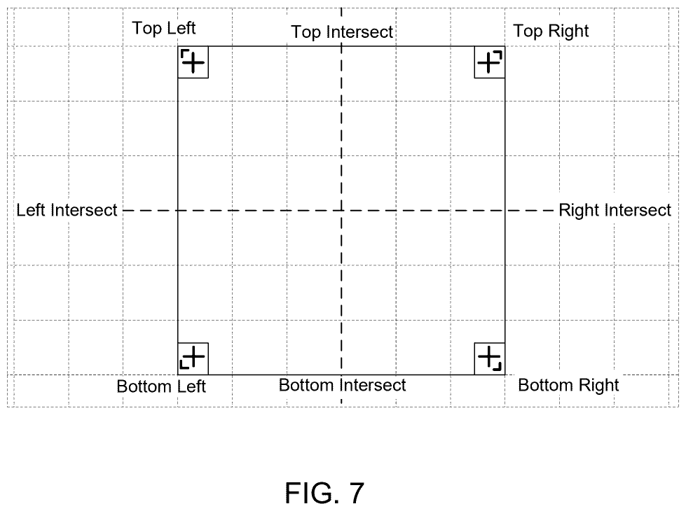

FIG. 7 is an example mockup chart 700 showing quadrant plots. In some implementations, the position of the cross-shaped off-plot indicator box reflects the location of the center of the off-plot quadrant gate center and the chevron icon points to the relevant corner of the plot. As depicted, when an off-plot quadrant gate center falls into the top left section of the chart, a cross in the top left of the plot is rendered, and when an off-plot quadrant gate center falls into the top right section of the plot, a cross in the top right of the plot is rendered, and so forth. In some implementations, when a quadrant center falls directly on one of the intersecting lines, a cross is shown in both sections. For example, when an off-plot quadrant center is off-plot and aligned with the left intersect, a cross is shown in the top and bottom left corners of the plot. In some implementations, both have identical behavior for axes expansion.

In some implementations, in response to receiving a mouse over of an off-plot gate indicator (e.g., the rectangular box), the cursor changes from the finger hover state to the standard selection arrow. In some implementations, single clicking the off-plot gate indicator expands the axis/axes to the extent of the furthest boundary of the off-plot gate(s). For quadrant plots, in some implementations, single clicking the cross shaped off-plot gate indicator expands the plot axes to encompass PnR max and display the center of the quadrant gate in the middle of the plot (if possible). In some implementations, rectangular off-plot gate indicators in quadrant plots behave as in histogram and dual-parameter plots.

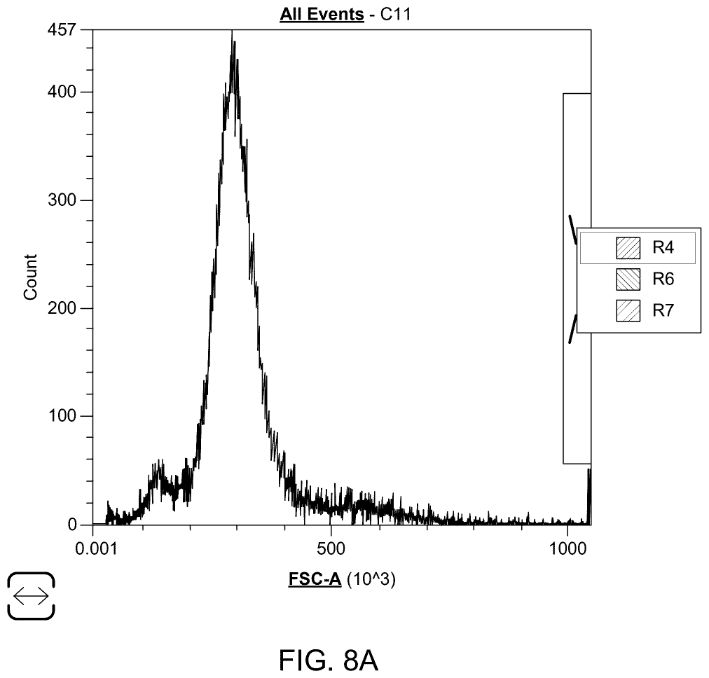

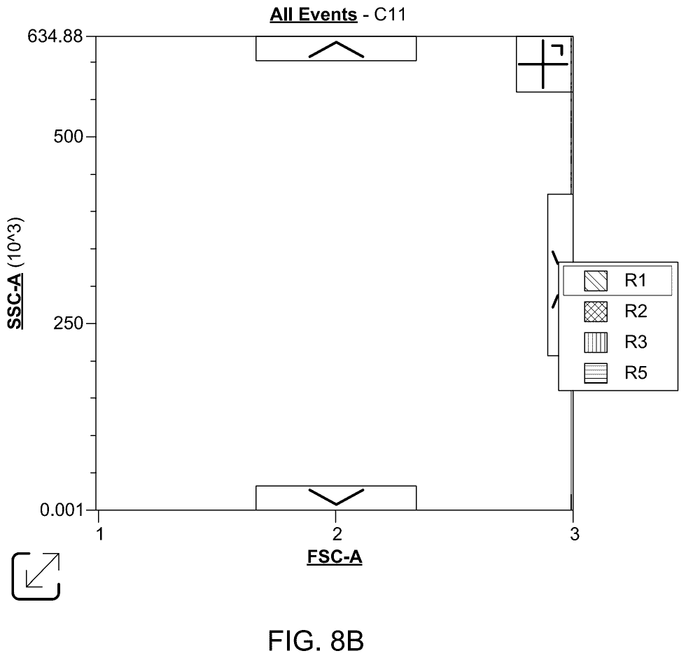

In some implementations, in response to receiving a right click on the rectangular off-plot gate indicator box chevron, a context menu is provided where off-plot gates are sorted (e.g., alphabetically) (see FIGS. 8A and 8B). In some implementations, receiving a selection of a gate of interest expands the axes to the extent of its bounds only. In some implementations, when a gate exists in the negative scale and a log scale is used, the scale is changed to HyperLog. Accordingly, gates that are still off-plot are still represented by an off-plot indicator box. In some implementations, when a gate or quadrant center is off-plot, no labels are present for the gate on the plot.

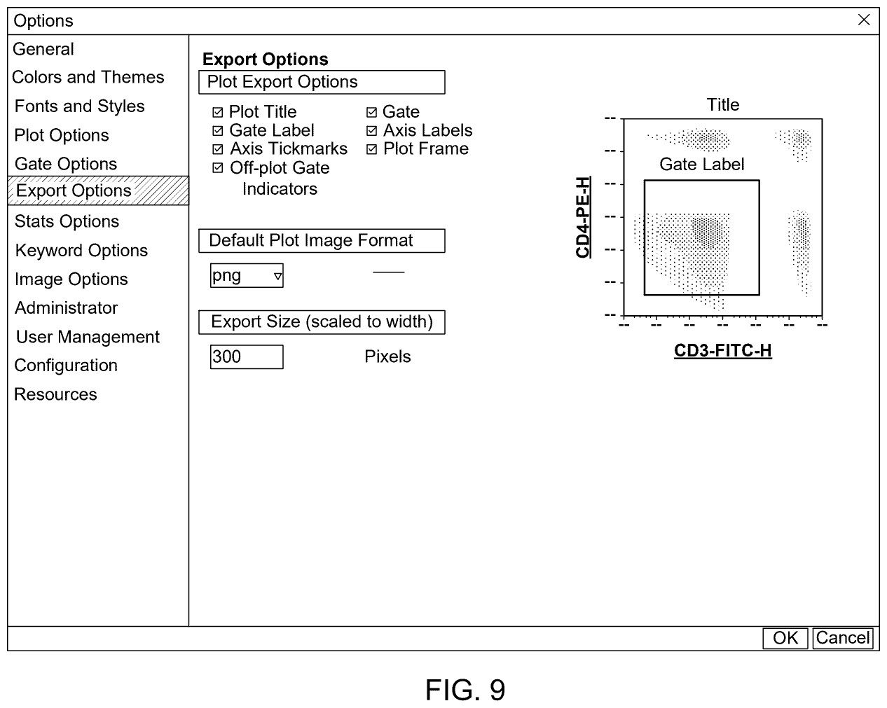

As noted above, in some embodiments, indicator(s) added to user interfaces as described herein may be exported when exporting a particular visualization (plot). For example, as illustrated in FIG. 9, a user interface may provide a user with the ability to export off-plot gate indicators, axis expansion indicators, or a combination thereof, through an “Export Options” section of a “Options” menu, such as, for example, via a check box.

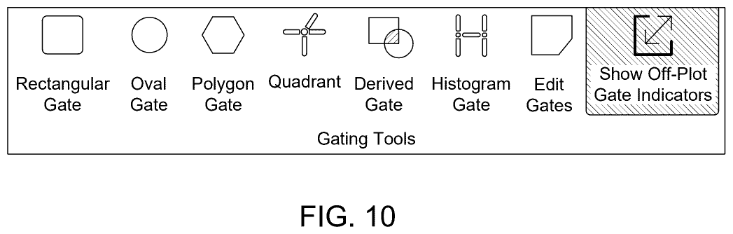

As also noted above, in some embodiments, functionality associated with the indicators described herein may be customized by a user to, for example, turn on and turn off functionality as needed or according to the user's preferences. For example, in some embodiments, the ability for users to toggle off-plot gate indicators on and off may be provided within a “Workspace” ribbon or menu provided within the data visualization application providing the user interfaces described herein (e.g., Attune Cytometric Software as provided by Thermo Fisher Scientific). In some embodiments, customization features may be included in a “Gating Tools” section, titled “Show Off-Plot Gate Indicators” (see, e.g., FIG. 10). As illustrated in FIG. 10, as one example, a checkbox may be provided associated with this functionality that may be labeled “Off-plot Gate Indicators” and a description associated with the checkbox may include “Enable or disable off-plot gate indicators.”

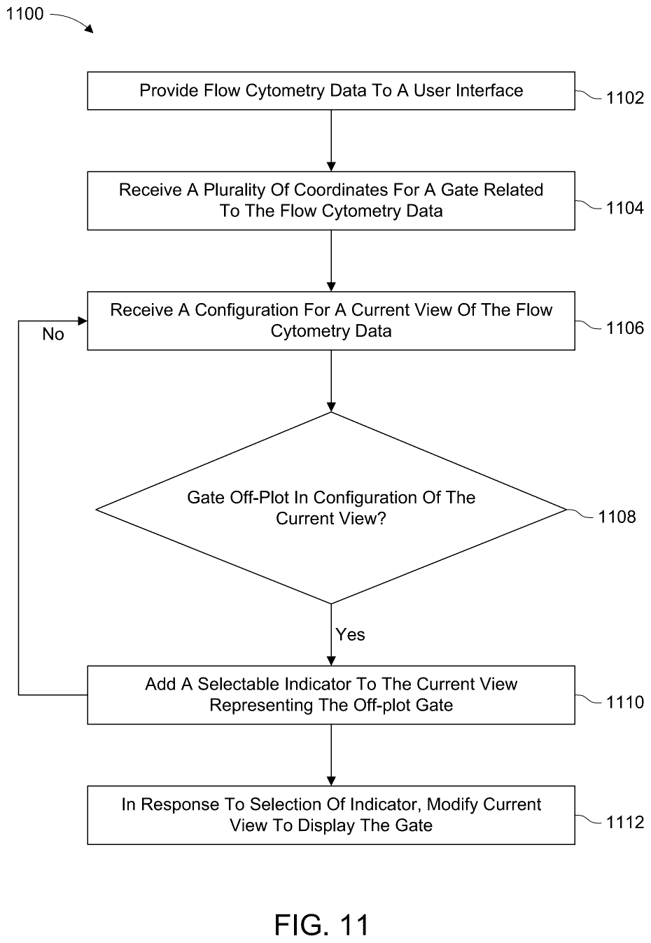

Accordingly, embodiments described herein provide methods and systems for providing selectable indicators within a current view of flow cytometry data for navigating the data and associated data visualizations. For example, one method 1100 illustrated in FIG. 11, executed by an electronic processor device, such as, for example, the computer system 1010 as described above, provides navigation data visualization navigation within a user interface. The method 1100 may include providing flow cytometry data, captured by an imaging device (e.g., the cytometry system 1020), to the user interface (e.g., as provided via the display 1004) (at block 1102). The method 1100 also includes, receiving, from the user interface, a plurality of coordinates for a gate related to the flow cytometry data (at block 1104). In some embodiments, the plurality of coordinates may be received from a user, such as, for example, via adding and/or drawing and resizing a shape to flow cytometry data included within the user interface.

The method 1100 also includes receiving, from the user interface, a configuration for a current view of the flow cytometry data (at block 1106). The configuration for the current view of the flow cytometry data may include a type of chart to display, a scale for one or more axes of the chart, a zoom level, or the like.

The configuration of the current view may force a gate to be off-plot such that the gate is no longer displayed within the current view. Accordingly, the method 1100 includes determining whether the gate is off-plot in the configuration of the current view (at block 1108). To determine whether a gate is off-plot, the method 1100 may compare the configuration for the current view to the coordinates of the gate (e.g., by comparing minimum and maximum access scales to the plurality of coordinates of the gate). In response to determining the gate is off-plot for the current view (e.g., based on the plurality of coordinates for the gate and the configuration for the current view), the method 1100 incudes adding a selectable indicator to the current view of the flow cytometry data representing the (now off-plot) gate (at block 1110).

As described above, the indicator may be positioned within the current view based on a direction that the gate is off-plot for the current view. In addition or alternatively, the indicator may include an icon representing a direction that the gate is off-plot for the current view within the data space.

In response to receiving a selection of the indicator, the method 1100 includes modifying the current view of the flow cytometry data to display the gate (at block 1112). Modifying the current view of the flow cytometry data includes modifying a minimum and a maximum of at least one axis. In addition or alternatively, modifying the current view of the flow cytometry data may include changing a chart type. For example, a chart included in the current view may be changed from a histogram to a biplot or may be changed from a biplot to a histogram. When changing the chart type, the scale may similarly be changed. For example, the scale of the current view may be changed to a HyperLog in response to the gate existing in a negative sale and the current view is using a log scale.

As described above, the selectable indicator may provide efficient modification of a current view (visualization) to include (display) a particular selected gate or a plurality of gates, such as, for example, all gates (e.g., using an axis expansion indicator). For example, as described above, an off-plot gate indicator may be selectable to access a list (menu) including one or more selectable icons, wherein each selectable icon is associated with a different off-plot gate. In some embodiments, the selectable icons may be displayed in a sorted fashion, such as, for example, in alphabetical (numerical) order, using labels or names automatically assigned to gates or manually specified by a user. In response to receiving a selection of a particular icon, the current view of the flow cytometry data is modified to display the gate associated with the selected icon.

Accordingly, the indicators described herein increase the speed and efficiency (in terms of user time and resources and computing resources) in navigating data visualizations of flow cytometry data within a user interface and, thus, represent an improvement in data visualization technology.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

As described above in the detailed description, reference is made to the accompanying drawings that form a part hereof wherein like numerals designate like parts throughout, and in which is shown, by way of illustration, implementations that may be practiced. It is to be understood that other implementations may be utilized, and structured or logical changes may be made, without departing from the scope of the present disclosure. Therefore, the detailed description as described above is not to be taken in a limiting sense.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future (e.g., any elements developed that perform the same function, regardless of structure).

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Various operations may be described as multiple discrete actions or operations in turn, in a manner that is most helpful in understanding the subject matter disclosed herein. However, the order of description should be construed as to imply that these operations are necessarily order dependent. In particular, these operations may not be performed in the order of presentation. Operations described may be performed in a different order from the described implementation. Various additional operations may be performed, and/or described operations may be omitted in additional implementations.

Implementations of the present disclosure are disclosed in the following clauses:
Clause 1. A method, executed by an electronic processing device, for navigating data visualizations within a user interface, the method comprising: providing particle data to the user interface; receiving, from the user interface, a plurality of coordinates for a gate related to the particle data; receiving, from the user interface, a configuration for a current view of the particle data; in response to determining the gate is off-plot for the current view based on the plurality of coordinates for the gate and the configuration for the current view, adding a selectable indicator to the current view of the particle data representing the gate; and in response to receiving a selection of the indicator, modifying the current view of the particle data to display the gate.
Clause 2. The method of clause 1, wherein the indicator is positioned within the current view based on a direction that the gate is off-plot for the current view.
Clause 3. The method of clause 1 or 2, wherein the indicator includes an icon representing a direction that the gate is off-plot for the current view within the current view.
Clause 4. The method of any of clauses 1-3, wherein modifying the current view of the particle data includes modifying a minimum and a maximum of at least one axis.
Clause 5. The method of any of clauses 1-3, wherein modifying the current view of the particle data includes changing a chart type.
Clause 6. The method of clause 5, wherein changing a chart type includes at least one selected from a group consisting of changing from a histogram to a biplot and changing from a biplot to a histogram.
Clause 7. The method of any of clauses 1-6, wherein modifying the current view of the particle data includes changing a scale of the current view to a HyperLog in response to the gate existing in a negative sale and the current view is using a log scale.
Clause 8. The method of any of clauses 1-7, wherein modifying the current view of the particle data includes modifying the current view of the particle data to display a plurality of gates.
Clause 9. The method of any of clauses 1-7, wherein the indicator includes an axis expansion indicator and, wherein, modifying the current view of the particle data includes modifying the current view of the particle data to display all gates.
Clause 10. The method of any of clauses 1-9, further comprising, in response to receiving a selection of the indicator, displaying a list including an icon for each of one or more gates.
Clause 11. The method of clause 10, wherein the icon for each of the one or more gates is included in the list alphabetically.
Clause 12. The method of clause 10, wherein modifying the current view of the particle data includes modifying the current view of the particle data to display a gate associated with a selected icon from the list.
Clause 13. Non-transitory computer-readable medium storing instructions executable by one or more electronic processing devices to perform a set of functions, the set of functions comprising: providing particle data to a user interface; receiving, from the user interface, a plurality of coordinates for a gate related to the particle data; receiving, from the user interface, a configuration for a current view of the particle data; in response to determining the gate is off-plot for the current view based on the plurality of coordinates for the gate and the configuration for the current view, adding a selectable indicator to the current view of the particle data representing the gate; and in response to receiving a selection of the indicator, modifying the current view of the particle data to display the gate.
Clause 14. A system for navigating data visualizations within a user interface, the system comprising: computer-readable medium storing a computer program; and one or more electronic processing devices configured to execute the computer program to: provide particle data to the user interface; receive, from the user interface, a plurality of coordinates for a gate related to the particle data; receive, from the user interface, a configuration for a current view of the particle data; in response to determining the gate is off-plot for the current view based on the plurality of coordinates for the gate and the configuration for the current view, add a selectable indicator to the current view of the particle data representing the gate; and in response to receiving a selection of the indicator, modify the current view of the particle data to display the gate.
Clause 15. The system of clause 14, wherein the particle data includes flow cytometry data.
Clause 16. The system of clause 14 or 15, wherein the particle data includes flow cytometry data captured via an imaging device.

What is claimed is:

1. A method, executed by an electronic processing device, for navigating data visualizations within a user interface, the method comprising:
providing particle data to the user interface;
receiving, from the user interface, a plurality of coordinates for a gate related to the particle data;
receiving, from the user interface, a configuration for a current view of the particle data;
in response to determining the gate is off-plot for the current view based on the plurality of coordinates for the gate and the configuration for the current view, adding a selectable indicator to the current view of the particle data representing the gate; and
in response to receiving a selection of the selectable indicator, modifying the current view of the particle data to display the gate.

2. The method of claim 1, wherein the selectable indicator is positioned within the current view based on a direction that the gate is off-plot for the current view.

3. The method of claim 1, wherein the selecting indicator includes an icon representing a direction that the gate is off-plot for the current view within the current view.

4. The method of claim 1, wherein modifying the current view of the particle data includes modifying a minimum and a maximum of at least one axis.

5. The method of claim 1, wherein modifying the current view of the particle data includes changing a chart type.

6. The method of claim 5, wherein changing a chart type includes at least one selected from a group consisting of changing from a histogram to a biplot and changing from a biplot to a histogram.

7. The method of claim 1, wherein modifying the current view of the particle data includes changing a scale of the current view to a HyperLog in response to the gate existing in a negative sale and the current view is using a log scale.

8. The method of claim 1, wherein modifying the current view of the particle data includes modifying the current view of the particle data to display a plurality of gates.

9. The method of claim 1, wherein the selectable indicator includes an axis expansion indicator and, wherein, modifying the current view of the particle data includes modifying the current view of the particle data to display all gates.

10. The method of claim 1, further comprising, in response to receiving a selection of the selectable indicator, displaying a list including an icon for each of one or more gates.

11. The method of claim 10, wherein the icon for each of the one or more gates is included in the list alphabetically.

12. The method of claim 10, wherein modifying the current view of the particle data includes modifying the current view of the particle data to display a gate associated with a selected icon from the list.

13. Non-transitory computer-readable medium storing instructions executable by one or more electronic processing devices to perform a set of functions, the set of functions comprising:
providing particle data to a user interface;
receiving, from the user interface, a plurality of coordinates for a gate related to the particle data;
receiving, from the user interface, a configuration for a current view of the particle data;
in response to determining the gate is off-plot for the current view based on the plurality of coordinates for the gate and the configuration for the current view, adding a selectable indicator to the current view of the particle data representing the gate; and
in response to receiving a selection of the indicator, modifying the current view of the particle data to display the gate.

14. The non-transitory computer-readable medium of claim 13, wherein adding the selectable indicator to the current view includes positioning the selectable indicator within the current view based on a direction that the gate is off-plot for the current view.

15. The non-transitory computer-readable medium of claim 13, wherein adding the selectable indicator to the current view includes adding an icon representing a direction that the gate is off-plot for the current view within the current view.

16. The non-transitory computer-readable medium of claim 13, wherein modifying the current view of the particle data includes performing at least one selected from a group consisting of changing a chart type and changing a minimum and a maximum of at least one axis and changing a chart type.

17. A system for navigating data visualizations within a user interface, the system comprising:
computer-readable medium storing a computer program; and
one or more electronic processing devices configured to execute the computer program to:
provide particle data to the user interface;
receive, from the user interface, a plurality of coordinates for a gate related to the particle data;
receive, from the user interface, a configuration for a current view of the particle data;
in response to determining the gate is off-plot for the current view based on the plurality of coordinates for the gate and the configuration for the current view, add a selectable indicator to the current view of the particle data representing the gate; and
in response to receiving a selection of the indicator, modify the current view of the particle data to display the gate.

18. The system of claim 17, wherein the particle data includes flow cytometry data.

19. The system of claim 18, wherein the particle data includes flow cytometry data captured via an imaging device.

20. The system of claim 17, wherein the one or more electronic processing devices are configured to modify the current view of the particle data by performing at least one selected from a group consisting of changing a chart type and changing a minimum and a maximum of at least one axis and changing a chart type.
